(19) United States
(12) Patent Application Publication
(10) Pub. No.: US 2008/0281969 A1
(43) Pub. Date: Nov. 13, 2008

(54) Controlling access to versions of application software by a server, based on site ID

(76) Inventors: John C. Horton, St. Paul, MN (US); David E. Carpentier, Lino Lakes, MN (US); Donald G. Smith, New Brighton, MN (US); Charles D. Steigerwald, Apple Valley, MN (US)

Correspondence Address: UNISYS CORPORATION, UNISYS WAY, MAIL STATION: E8-114, BLUE BELL, PA, 19424, US

(21) Appl. No.: 09/738,852

(22) Filed: Dec. 15, 2000

(51) Int. Cl. G06F 15/16

(52) U.S. Cl. 709/227; 709/203

(57) ABSTRACT

A plurality of versions of software application programs can be handled by a single server serving multiple user-clients who each need access to specific ones of the plurality of versions. Thus such different versions can run simultaneously without requiring upgrading of early versions and no interference between versions. A particular version is given a SiteID that a user request calls, and a table in the server is consulted to keep track of which SiteID corresponds to which version and to assign each request to the appropriate version. A directory or registry must be set up to accommodate the table which must be consulted for each request. No significant change need be made in any version of the software application program since the table is created at installation time on the server and the SiteID's are assigned to the users when they get rights to the particular version of interest by an administrator. In a preferred embodiment, a SiteID identifies (and the “site” embodies) a collection of databases that the user may need access to. One and only one application software version is associated with a SiteID. Accessing a table that maps the SiteID to a particular version can be monitored and additional programs run responsive to information about such access.

A portion of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

1. Field of the Invention

This invention relates generally to computer system handling of requests for access to software applications and controlling that access for allocation of proper software resources to users issuing such requests.

2. Background Information

When there are multiple versions of a user software application program running on a single server, it is important that each client of the server be able to conveniently and efficiently be connected to the version that client is expecting. Otherwise compatibility problems will occur which can affect the user's ability to use the software.

The most common problem is in installation and testing of new versions of database and similar multiple user transaction processing software, although the solution described herein has applicability to any user-accessible software application program that has multiple versions which can exist on a server at a single time. In the change over from one version of a database program to another, it will be advantageous to run the old version on the same server as the new version for many reasons that are apparent to anyone who has been involved in such software changes. No requirement for duplicate hardware is one reason, ability to test the specific configuration of the network without rework is another. Thus, a single set of data can be duplicated and the duplicate used to run from test locations while the original software version continues to service the original data.

The solution described herein also provides for additional advantages that can be used for other purposes besides providing a smooth upgrade solution for the customer. For example, the solution described within provides a way for multiple users with different billing rates and access rights to have those efficiently handled. Such alternate uses for the invention described herein are disclosed in greater detail below.

### BRIEF DESCRIPTION OF THE DRAWINGS

FIG. 1 is a block diagram for use with a preferred form of the invention.

FIG. 2 is heuristic diagram of a message used in a system like the network of FIG. 1 to implement a preferred embodiment of the invention.

FIG. 3 is heuristic diagram of a memory area on a server in accord with a preferred form of the invention.

FIG. 4 is a block diagram of software processes used in a server-client interaction in accord with a preferred embodiment of the invention.

FIG. 5 is an alternative illustration of server utilization in accord with this invention.

FIG. 6 is a flow chart in accord with a preferred form of the invention.

FIG. 7 is a block diagram of a server with components functioning in accord with a preferred embodiment of this invention.

### SUMMARY OF THE INVENTION

A plurality of versions of software application programs can be handled by a single server serving multiple user-clients who each need access to specific ones of the plurality of versions. Thus such different versions can run simultaneously without requiring upgrading of early versions and no interference between versions. A particular version is associated with one or more SiteIDs. A user request specifies the desired SiteID, and a table in the server is consulted to keep track of which SiteID corresponds to which version and to assign each request to the appropriate version. A directory or registry must be set up to accommodate the table which must be consulted for each request, thus creating a mapping and a link to call the program and associated data for the SiteID. No significant change need be made in any version of the software application program since the table is created at installation time on the server. The application administrator grants users access to the particular site or sites of interest by assigning the SiteID to the user and putting the appropriate data regarding that SiteID into the table, so that the table contains information about what version maps to each SiteID, and any associated database(s) which also maps to that SiteID. In a preferred embodiment where the application software is MAPPER from Unisys Corporation, and the operating system is a version of Microsoft's Windows, the table is in the form of a “registry”. The administrator registers within a site database, a login for the user in order to validate access to the site.

Many other features and limitations are described in the detailed description below.

### DETAILED DESCRIPTION OF THE PREFERRED EMBODIMENTS

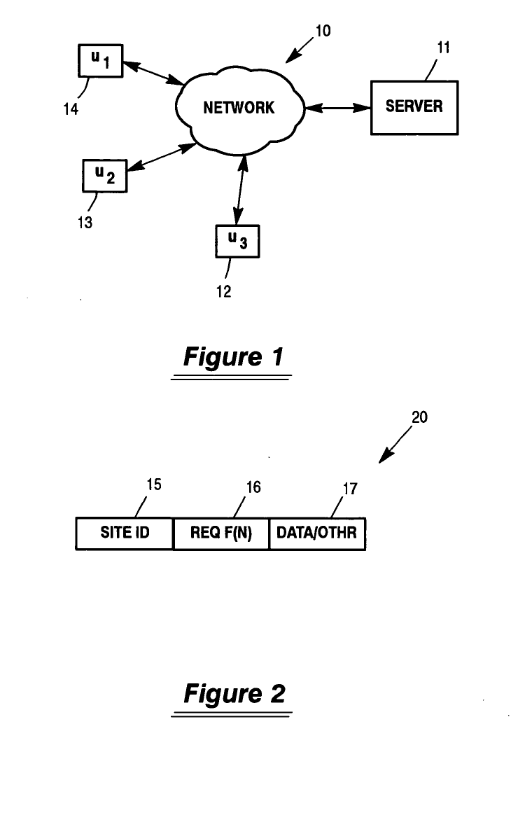

Refer first to FIG. 1 in which a network 10, connects a number of pieces of user equipment U1-3, 14, 13, 12, respectively, to a server 11. The network can be of any variety including LAN, WAN, Internet or any combination of networks so long as the communications detailed herewithin can be handled through it for the purposes of this invention. The server 11 will contain at least two versions of application software that a user may need to access through the network from one of his computer systems U1-3. In the first instance of the inventors' use of this invention, MAPPER™ software was used on a Unisys server platform, and levels 6 and 7 were simultaneously made available for users. There are different types of users which use MAPPER software. Whether it is a developer level user or an application user level user, the principles of this invention apply with equal force to permit multiple versions of the MAPPER or other user accessible software to be used simultaneously on a single server without forcing all versions to be upgraded.

There are numerous reasons for this to be a requirement. In a first example, a subset of users with access to a particular server need to retain aspects of usability built into a particular version of a piece of software while new users may require some of the “upgrade” feature set available only in the new version a manufacturer has just released. By employing this invention both the new set of users who want the new features and the old users who want to retain legacy functionality (perhaps because their data structure cannot be rebuilt in a new version of a database, for one example, or because a particular query is no longer supported for another) can be accommodated on a single server.

In this inventive system, the server must keep track of which version of the software the particular user wants to access at each request by the user, not by the username but by SiteID. SiteID can be used by multiple users on the same server. Accordingly, in FIG. 2, a message 20 requesting the server to connect a user with a particular site is shown, having the SiteID of said site 15, included in the message 20 along with whatever else is required to initiate a request from the server. In this example, the requested function 16 and an area of data or other information 17 is included in the example message 20.

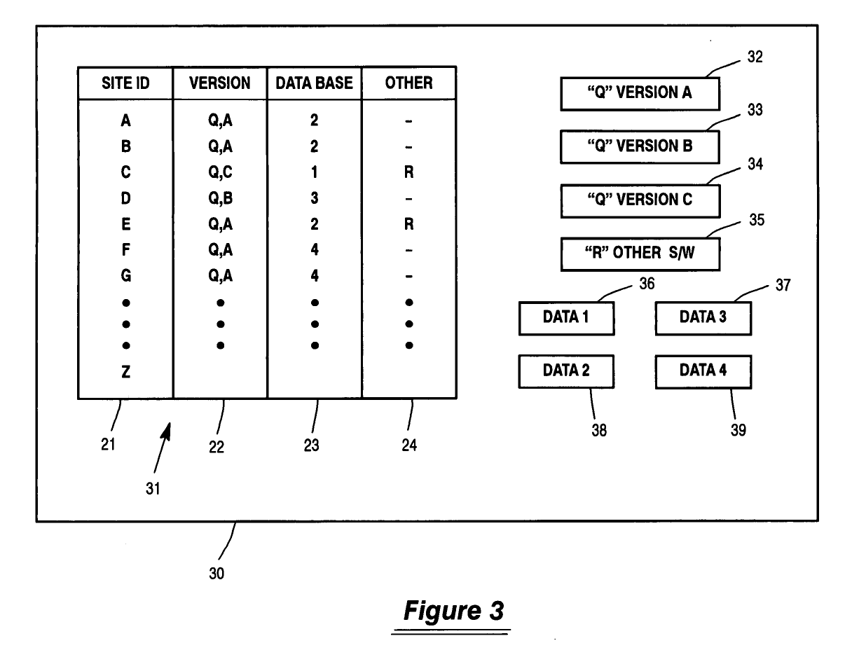

Accordingly, the server must maintain in its memory a directory to accomplish the appropriate assignment of the resources to the user to satisfy the user's request with the appropriate software level needed. In FIG. 3, a block diagram representation of the data space or memory 30 of a server implementing the instant invention is drawn with a directory 31 and various components of software and data 32-38 that would also be found within said memory 30. The directory 31 has a list of SiteID's “A”-“Z” although any representation could be used, in most instances there will be less than 26 versions of a kind of software maintained so the letters of the standard English alphabet serve well in this capacity. Only A-G are listed in column 21. In Column 22, the name and version of the application software is indicated, which maps to the location of that version of that application software in the memory system 30 of the server. Thus, the application program named “Q” version A is found as indicated in block 32, and the representation in column 22 would in most preferred embodiments list the current installation directory or other relevant location information of the program Q, version A (32). In many embodiments a column 23 for the database itself will be linked to the SiteID through information in column 23. In this instance the user identifies a SiteID “A” when making a request for service by software called “Q”. If he is using SiteID A, he will be linked to database 2 (38), but notice also that if he issues SiteID F he will be linked through table 31 to database 4 (39). The user does not need to know he is also specifying a particular version using a given SiteID. The table 31 handles this match-up. The table can be extended to link some SiteID's to other software, here illustrated as other software “R”, 35, run by SiteID's C and E. This extension is only one example of many that can be made given the principles of this invention. For another example, if all requests have a branch of the request sent to a billing system, an ASP (Application Service Provider) could monitor use of particular SiteID's by particular users and charge different billing rates for the differing actual usage.

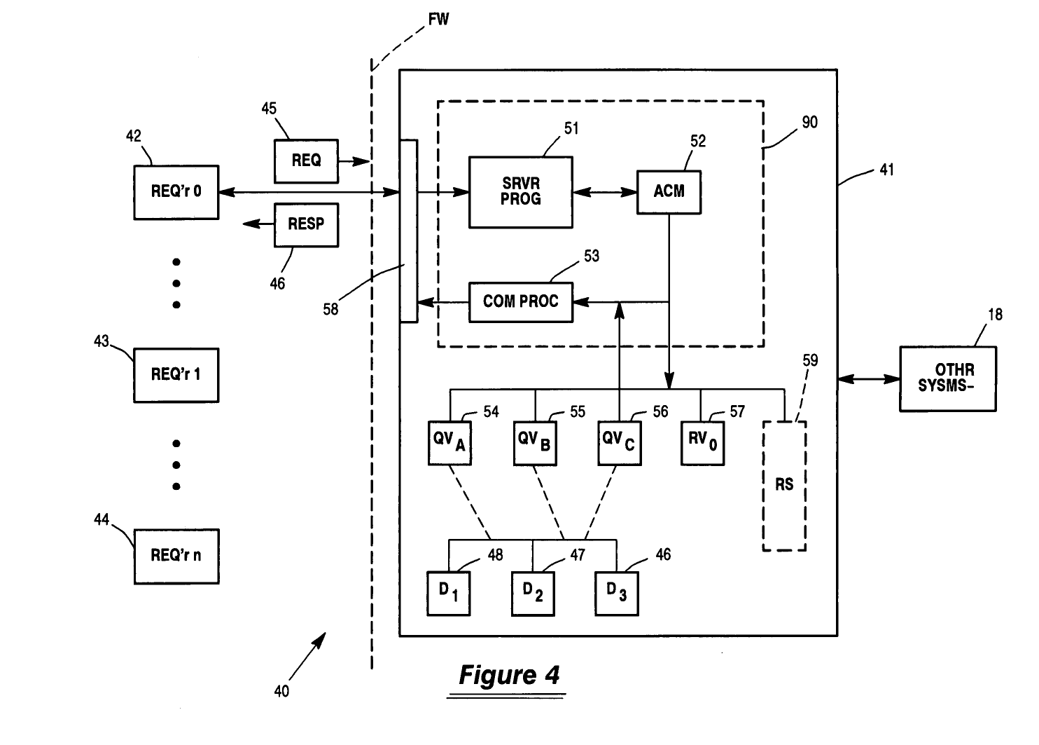

FIG. 4 illustrates some of the components of the architecture of a system 40 using a preferred embodiment of the invention. The server 41 can be connected, directly or through a firewall FW to various requesters, here requestors 0-n (42-44, respectively). A requestor could be a web browser, a client-user piece of equipment of any kind, even a site running versions of the software application being run on the server 41. Each requester may generate a Request For Service (REQ) 45 as is shown here for requester 42, and each can receive a response (RESP) 46, shown here for the same requestor generating the REQ. If the invention is implemented through the internet a web server will handle the listening function of the server program 51 in the server 41, which constantly “listens” to a port 58 that the users' systems (here requesters 42-44) will be sending REQ's into on the server 41. As illustrated in FIG. 2, the REQ will have a component of information that contains the SiteID, and this will be forwarded to a component program in the server we can call an Access Control Manager or ACM 52. The ACM will use this information to check a list or table like the table of FIG. 3 which will contain information indicating which application program version and which database this user requires for this request. The ACM will then spawn an instance of a communication process or program ComProc 53 which will handle the generation of a RESP to the REQ for this user. The ComProc will be connected to the appropriate version and pass information from the version back to the requestor after the version has handled the request. Several things should be noted here. The requested version of the software application program may get the data to be processed from the requester in a single step, directly from the ACM or the server program, or may get it through the ComProc on the initial request. This would normally be the case in web and transaction environments. Alternatively, the data to be processed (or command to be followed or both) by the application program version can be sent on a subsequent REQ from the requester through the ComProc after an acknowledge and identification of the ComProc instance is made to the requester through a RESP. In this later instance, the ComProc can direct further communication related to the initial REQ through a different port. This would be the case for the MAPPER application mentioned earlier, or any server application that uses an interactive client interface. Also, even if the initial REQ is handled in a single step, further processing that may be related to the initial REQ could be directed to an alternate port by the ComProc.

Particular versions of network listening programs and ways to hand-off communication to another program within a server environment are illustrated in U.S. Pat. No. 5,903,732, issued to Reed et al, and also in U.S. patent application Ser. No. 09/620,047, filed in July of 2000 by Krack and Condon and assigned to the assignee of this application. These references are hereby incorporated by this reference in their entirety.

In a presently preferred embodiment, where we implement the invention with MAPPER as the application software, the ACM and the linking program are housed within the network listening program. The combined program (illustrated by the dotted line 90) receives the incoming client REQ, performs the version mapping table lookup to get the software version associated with the requested SiteID, and spawns a server process to handle the REQ. The spawned process (which itself includes the version of MAPPER the user has asked for by using his SiteID information in the REQ) takes over network communication for the connection from the listening program. Thus there is not a separate ComProc process for each active connection. However, the separate pieces described herein provide the needed information regarding the functioning components of the system one of ordinary skill in this art would use to construct alternate embodiments of the invention.

Also in FIG. 4 it should be noted that the databases D1-3 (48-46, respectively) are all available to the versions of software application QVA-C (54-56, respectively). In embodiments using MAPPER software as the application program, at any point in time a database is associated with one and only one version. It is assumed that the information as to which database to employ will be in the initial REQ and that this information will be passed to the instance of the application software program running at the behest of the initial REQ. Alternate methods to connect the database or other data with the instance of the version of the application software running at the behest of the initial REQ may be used if desired.

In FIG. 4 there is also a block 57 which indicates that other software can be connected to the REQ, and a block 59 to indicate that one of these other pieces of software could be simply recording usage by particular users for maintenance or billing purposes if desired. It could also be used to perform administration tasks for the target software application(s). Further, other systems 18 can be connected to the server 41 which can provide additional room for larger databases than are on the server 41 but which could be accessed by the requesters through the server program 51, or for other purposes as may be useful to the owners of the server.

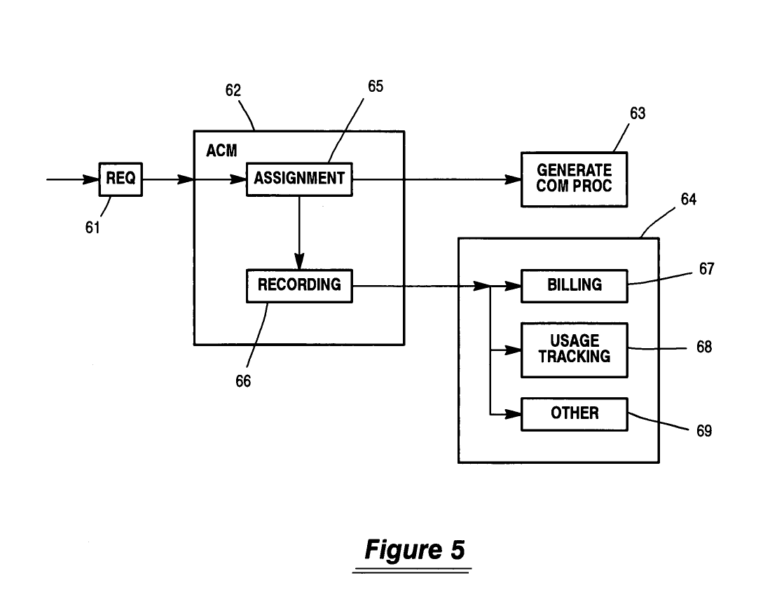

FIG. 5 shows a little more detail for the ACM function in the server. The request REQ 61 reaches the ACM 62, whereupon an assignment section 65 reviews the table against the SiteID information in the REQ. The assignment section generates a ComProc 63 and sends appropriate information about the requestor and SiteID related information to a recording section 66, which in turn reports this information to a billing 67, usage tracking, and other programs 69 which may make use of the information to service the requestor. Components 63 and 64 may be integral to the ACM or separate programs called by the ACM 62.

In order to have this work on typical installations, the administration facilities need to be aware of all currently installed copies of each version of the application software. This will include awareness of installation directories, software version levels, configurations and the state of each site associated with each installation. Previously installed levels need to be upgraded or modified in order for them to be capable of receiving messages through REQs in the form the particular ACM may put them. In a Microsoft Windows™ operating system environment, a registry structure needs to be set up to accommodate this invention. In Unix, a list must be maintained through a directory structure. In the data structure below, we illustrate how a registry structure should be constructed to implement one embodiment of this invention in a Windows environment, for the Unisys MAPPER™ database and programming environment application software product. This can easily be modified by one of ordinary skill in the art to accommodate other multi-versioned application software programs.

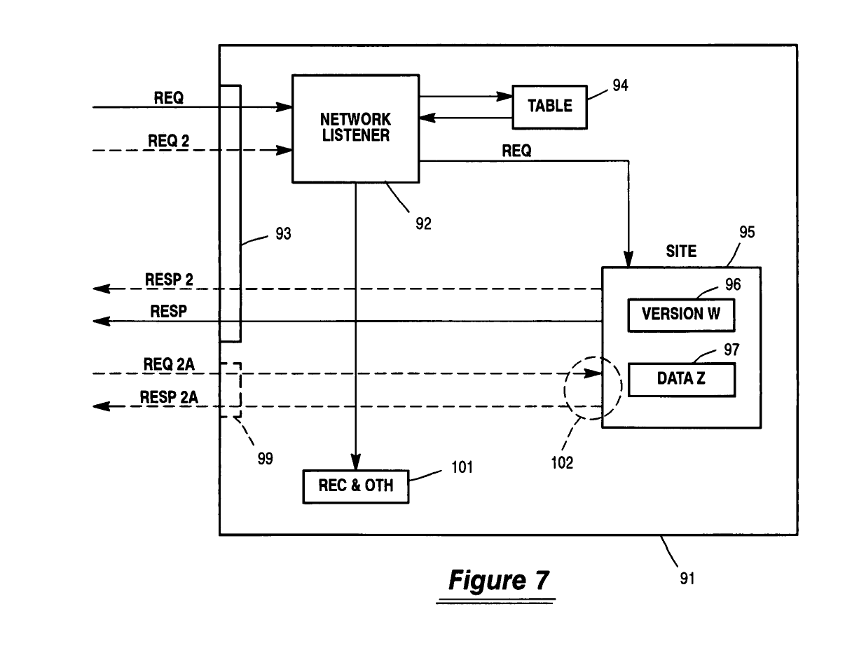

It may be useful to see the arrangement in another form and so refer to FIG. 7 in which a server 91 is shown. A first request REQ is received by the Network Listener program 92, which looks up the SiteID information in the table 94, so that it can direct at least the informational part of the request to the correct site 95. A site is a logical combination of the version of the software 96 and any data 97 required for the software application program 96 to run for this client and service the request. Shown here also are two second requests REQ 2 and REQ2A. In one version, REQ2 will use the same path and the response path for RESP and RESP 2 will be the same, through a communications link (which could be a port or a port and a program) 93. It is possible however, that complete control of further handling of requests from a client can be transferred to the site 95, in which case the first response RESP would contain an address for a different communications link 99 so that subsequent requests from the same client for Site 95 will go through communications link 99 and responses RESP 2A will be also handled through link 99. A communications program 102 may be included for handling this alternate request/response route through communications link 99 with an instance spawned for within or interfacing with the site 95.

Here, in the embodiment illustrated in FIG. 7 too, a secondary set of programs 101 may record the handling of the request REQ by the Network Listener 92, and provide the server with the ability to provide different billing rates to clients who use different Sites, allow for more effective maintenance and perhaps enhanced security on server 91. Using this information may even permit reconfiguration on the fly of large multiprocessor servers such as the Unisys ES7000 to provide more overall capacity and thus improved throughput for sites that are most heavily used even as such usage changes.

To understand the details of how the table or directory or registry is set up, we use Microsoft set-up notation set forth just below this paragraph. Please first note that this directory is set up on the server (Local Machine), for the software MAPPER. The component parts include Installed Copies, Services, and Sites. In reading this notation, a series of three periods ( . . . ) indicates multiple copies (as needed for the particular installation) of the item immediately preceding the ellipses. Items enclosed in brackets ([ ]) indicate that the actual value is determined at the time of software installation or site creation. In Microsoft terminology each bolded item is known as a ‘key’; each non-bolded item is known as a ‘value entry’. In the first example, [Description] . . . should be read as there are potentially multiple instances of Description, with all the parts thereof (BldLev, i.e. build level, CurrentLevel, et cetera) included under each key at this level. Description names could be for examples, a phrase, letter or code indicating for example that this is a test, or a development, or a production level of the software. Note that all Description keys are contained within the InstalledCopies key.

Under the key “Sites” are found one or more unique [Site] . . . keys. The value “Site” would be what the ACM looks to, to find which version (Description) to match-up with each REQ. The MAPPER System values are probably unique to the program MAPPER and other programs would use different values.

HKEY_LOCAL_MACHINE

SOFTWARE

Unisys

MAPPER System

Installed Copies

[Description]...InstallDirectory“[mroot]”

Installation

| | |
|---|---|
| BldLev | “[level]” |
| CurrentLevel | “[Release version |

(including stability level)]”

ICLev “[Interimcorrection

level]”

| | |
|---|---|
| Program Group | “MAPPER |

System

for Windows NT [Version]”

SiteInstalled “[Y/N]”
SetupType“[Typical/Custom]”

Services

| | |
|---|---|
| GroupName | “MAPPER” |
| GuestPassword | “” |
| GuestUserName | “MAPPERGuest” |
| StartPrograms | “[commandline]” |
| IPC | |

IPCSOCKET
MAXSEMSETS
MAXSEMSPERSET
SHMBASEADR
SHMSIZE

| Network | |
|---|---|
| MAPPERServicePort | “3985” |

| | |
|---|---|
| WorkstationServicePort | “3986” |

Sites

| | |
|---|---|
| DefaultSite | “[site]” |

| | |
|---|---|
| SitesDirectory | “[directory]” |

[Site]...

| | |
|---|---|
| Version | “[Description]” |

MAPPER Parameters

| | |
|---|---|
| *AutoStart | [boolean value] |
| [parameter]...[value] | |

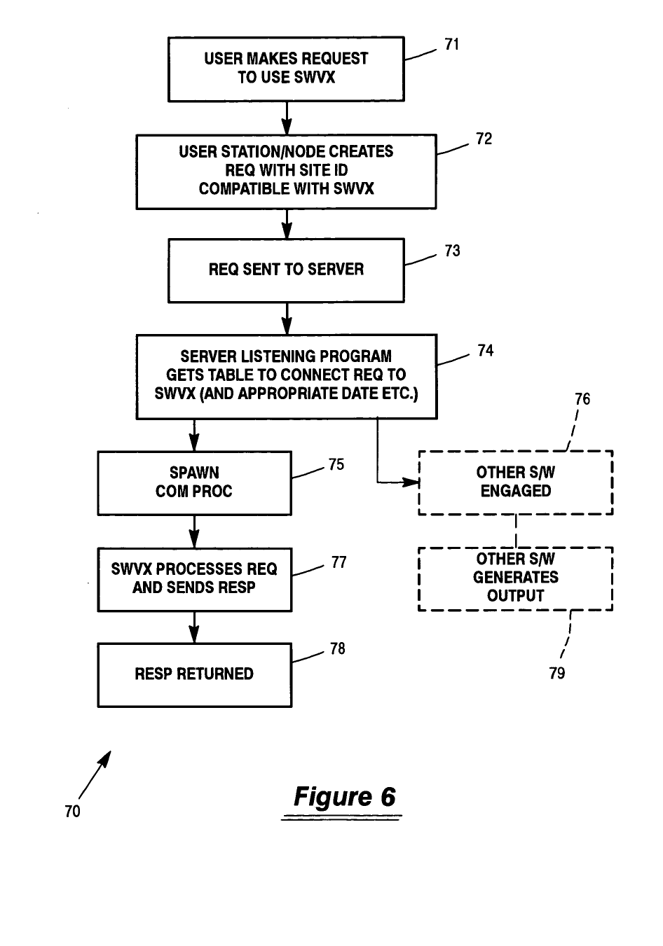

Refer now to FIG. 6, in which the general process 70 is described. Beginning with the user making a request to run a process using a version of the software (SWVx) 71, the client creates a REQ in accord with the description above 72 where it includes the SiteID for the site the user wants (which will be translated into the version and database information as described above when it arrives in the server), and sends 73 that REQ to the server having the SiteID located thereon and the table for understanding the SiteID information in the REQ. The server listening program receives the REQ, assuming the network is working, and enables the program which retrieves and looks at the table of SiteID related information 74. In most preferred embodiments the server will spawn a communications process to handle the REQ and the RESP to be returned 75. The communications process or other program within the server handles connecting the REQ to the SWVx program in accord with the information in the table. The SWVX then process the REQ and sends out the information required for a RESP (response) either through the communications process or other mechanism available in the server 78.

Preferably at a time when the table is being consulted to determine which version of the software application program and any associated programs and data are required by the particular REQ, other software programs are engaged 76. These other software programs thus have the information regarding user usage of the system and can easily track user usage for maintenance or billing or other purposes as desired. These other software programs can generate output such as bill statements to the users at the end of a month, or usage reports for systems maintenance for the owners of the server, for example.

It should be recognized that in order to perform the steps in the flow chart 70, the system will have had to have been configured. In one preferred embodiment, an application administrator will have had to set up each user login to the server and to each “site” to which the user wishes to provide requests (REQ's) that contain the SiteID. Also, the server will have to have had a table constructed as indicated above, which can be in any of the forms mentioned above. Likewise, the Access Control Manager program will have to be installed on the server to handle the REQs, interpret the SiteID information in them and connect the REQs to appropriate “sites.” This configuration can be done with MAPPER systems currently available from Unisys Corporation, and Microsoft Windows software using the registry for the table. This does not preclude using other forms of access control manager programs, Unix, or other software components from other manufacturers which have the characteristics described herein. However, in some preferred embodiments the user will not have to set up the SiteID code in his requests, because the login set-up will have done it for him, and he can be completely unaware of the sending of the SiteID code with his request. A default site can be used for users which send no SiteID code also. Using the server tables as indicated herein will allow for multiple users to access the same sites on a server if their requests contain the same SiteID.

Accordingly this invention is only limited in scope by the following appended claims.

1. A system for assigning each one of a plurality of versions of a software application to specific requests from specific users handled by a server comprising a processor and a memory, wherein more than one of said plurality of versions of a said software application is executing on said server and available to service requests from users on said server, and wherein said specific users are provided access to said server by issuing requests to said server, and wherein said requests have a SiteID code in each said request, said system comprising:
a network listening program executing on the processor of said server for receiving said requests by said users for use of a said software application program version,
a table stored in the memory of said server containing correspondences between ones of a plurality of sites and ones of said SiteID codes, said correspondences logically connecting a one of said more than one version of a said software application program to a one of said plurality of sites indicated by said SiteID code, wherein said one of said plurality of sites has only one of said more than one version of a said software application program and at least one data area,
an access control manager program executing on the processor of said server for determining which one of said more than one version of a said software application program should service each user request by reference to said table,
a linking program executing on the processor of said server for passing each request to a respective one of said sites based on the determination by said access control manager so that the determined site processes the request and generates a response to the request.

2. The system of claim 1 wherein said table is a registry in a Microsoft Windows operating system.

3. The system of claim 1 wherein said access control manager program is part of said network listening program.

4. The system of claim 3 wherein said linking program is part of said network listening program.

5. The system of claim 1 wherein said network listening program comprises a web server.

6. The system of claim 1 further comprising an auxiliary recording program for monitoring each request for ones of said plurality of sites and recording user information related to said each request.

7. The system of claim 6 wherein said auxiliary recording program supports billing programs that can bill for client usage of particular ones of said plurality of sites.

8. The system of claim 6 wherein said auxiliary recording program supports maintenance programs that improve server performance.

9. The system of claim 1 wherein said linking program communicates requests and responses between a one of said plurality of sites and said client after a first request is handled by said network listener program.

10. The system of claim 9 wherein said access control manager program spawns said linking program based on a said first request.

11. The system of claim 1 wherein said software application is a database application.

12. The system of claim 11 wherein said software application is the program called MAPPER available from Unisys.

13. A system for assigning each one of a plurality of versions of a software application to specific requests from specific users handled by a server comprising a processor and a memory, wherein more than one of said plurality of versions of a said software application is executing on said server and available to service requests from users on said server, and wherein said specific users are provided access to said server by issuing requests to said server, and wherein said requests have a SiteID code means in each said request, said system comprising:
a network listening means executing on the processor of said server for receiving said requests from a network connected to said server by said users on said network for use of a said software application program version,
a table means stored in the memory of said server containing correspondences between ones of a plurality of site means and ones of said SiteID code means, said correspondences logically connecting a one of said more than one version of a said software application program to a one of said plurality of site means indicated by said SiteID code means, wherein said one of said plurality of site means has only one of said more than one version of a said software application program and at least one data area,
an access control manager means executing on the processor of said server for determining which one of said more than one version of a said software application program should be connected to each user request by reference to said table means,
a linking program means executing on the processor of said server passing each request to a respective one of said site means based on the determination by said access control manager so that the determined site means processes the request and generates a response to the request.

14. A method for passing user requests to particular versions of a software application program executing on the server, where multiple versions of said software application program are executing on said server and available to service requests from users, the method comprising:
receiving a user request at a server,
reading a SiteID code identifying a user site from within said user request,
determining with reference to a table which one of a plurality of versions of a software application program executing on said server is indicated by said request,
passing said request to said one determined version of said software application program so that the determined version processes the request and generates a response to the request.

15. The method of claim 14 wherein said passing further comprises;
forwarding information from said request from a network listening program which performed said receiving step to a logical site on said server containing at least said one version,
allowing said one version to process said information from said request and formulate a response responsive thereto, and
returning said response to said user.

16. The method of claim 15 wherein said returning step comprises:
passing said response to a communications program and communicating by said communications program information from said response to said user.

17. The method of claim 15 further comprising:
spawning an independent communications process for handling communications between said site and said user.

18. The method of claim 14 further comprising sending information identifying said user as having been connected to said one site to an auxiliary program.
